(19) United States
(12) Patent Application Publication
(10) Pub. No.: US 2002/0171999 A1
(43) Pub. Date: Nov. 21, 2002

(54) Computer USB HUB and card reader combining device

(76) Inventor: Cheng Yu Huang, Taipei (TW)

Correspondence Address: TROXELL LAW OFFICE PLLC, 5205 LEESBURG PIKE, SUITE 1404, FALLS CHURCH, VA, 22041, US

(21) Appl. No.: 10/097,548

(22) Filed: Mar. 15, 2002

(30) Foreign Application Priority Data
May 2, 2001 (TW) 091201361

(51) Int. Cl. G06F 13/00; H02B 1/00

(52) U.S. Cl. 361/600

(57) ABSTRACT

A plug-in and build-in computer USB HUB and card reader combining device is provided, which includes a USB receptacle for being inserted by the USB (Universal Serial Bus) HUB terminals and card reader for reading and writing data. The computer USB HUB and card reader combining device can be a plug-in computer USB HUB and card reader the power of which is supplied from a DC converter or be a built-in computer USB HUB and card reader which can be placed on a computer disk rack and has power from a power supply in the computer Thereby, the user can derive a convenient computer USB HUB and card reader combining device.

### BACKGROUND OF THE INVENTION

1. Field of the Invention

The present invention relates to USB HUBs and card reading devices, and particularly to a computer USB HUB and card reader combining device.

2. Description of Related Art

To simplify the connection between computers and the peripheral devices, universal series bus (USB) is developed, which can be used with hubs so that the peripheral device can be inserted into the receptacle of the USB HUB to connect the peripheral device with a computer.

Hard disks, soft disks, and compact disks are popular computer storing medium. Computers read data from and write data to these disks through disk drives. In general, hard disk drive is retained in a computer mainframe for fixing a hard disk, while the hard disk drive is portable through a mobile rack. However, since it is heavy and has a large weight and thus it is not suitable as a portable storage medium. Therefore, soft disks and compact disks are most frequently used storage mediums, but the capacity of a soft disk is small and in general, the compact disk is a write-once device. It can not be written repeatedly. Moreover, if it is desired to write data into a compact disk, a CD recorder is necessary, while the recorder is expensive and not suitable for being carried out.

Due to above mentioned defects of the prior art storage medium, manufacturer has developed memory cards with sufficient capacities and a small volume, such as C F (Compact Flash)-S D-M M C-Memory-stick & Smart-media, etc. Currently memory cards are widely used in digital cameras, MP3, and other computer peripherals; the memory cards can be accessed through an external card reader of a computer mainframe or a portable computer, generally, flash elements are existed in a card reader. Thereby, data can be stored in a memory card and thus is carried out.

From above description, it is apparent that USB HUB and memory cards have respective advantages. The present invention combines the two devices and thus a plug-in and built-in computer USB HUB and card reader combining device is invented. The computer USB HUB and card reader combining device can be a plug-in computer USB HUB and a card reader the power of which is supplied from a DC converter or be a built-in computer USB HUB and a card reader which can be placed on the computer disk rack and have power from a power supply in the computer Thereby, the user can derive a convenient computer USB HUB and card reader combining device.

The various objects and advantages of the present invention will be more readily understood from the following detailed description when read in conjunction with the appended drawing.

### BRIEF DESCRIPTION OF THE DRAWING

FIG. 1 shows one embodiment about the plug-in computer USB HUB and card reader of the present invention.

FIG. 2 shows one embodiment about the built-in computer USB HUB and card reader of embodiment.

### DETAILED DESCRIPTION OF THE PREFERRED EMBODIMENTS

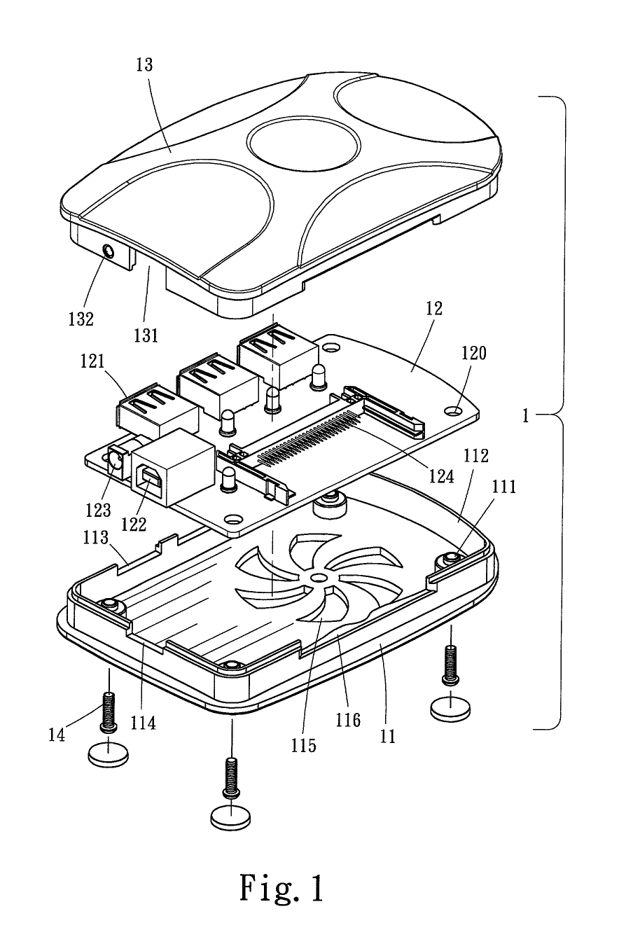

The present invention relates to a shared plug-in and built-in computer USB and card reader, as illustrated in FIG. 1. The plug-in computer USB HUB and card reader 1 has a box seat 11, a circuit board 12 and an upper cover 13. The box seat 11 has screw holes 111, a flange 112, an upper cover 13, a USB output terminal notch 114, a hole 115, a memory card inlet 116, etc.

The circuit board 12 has a plurality of penetrating holes 120, a USB HUB input terminal 121, a USB HUB output terminal 122, a DC power terminal 123 and a card reading element 124. DC power from an external power transformer is inputted from the DC power terminal 123.

The upper cover 13 is installed with a USB output terminal notch 131, a DC power terminal notch 132 and threads. Thereby, the screws 14 may be screwed into the box seat 11 so that the circuit board 12 and upper cover 13 can be formed as an integral body. Then they are connected to a computer mainframe so that the user can use the functions of card reading of USB and HUB.

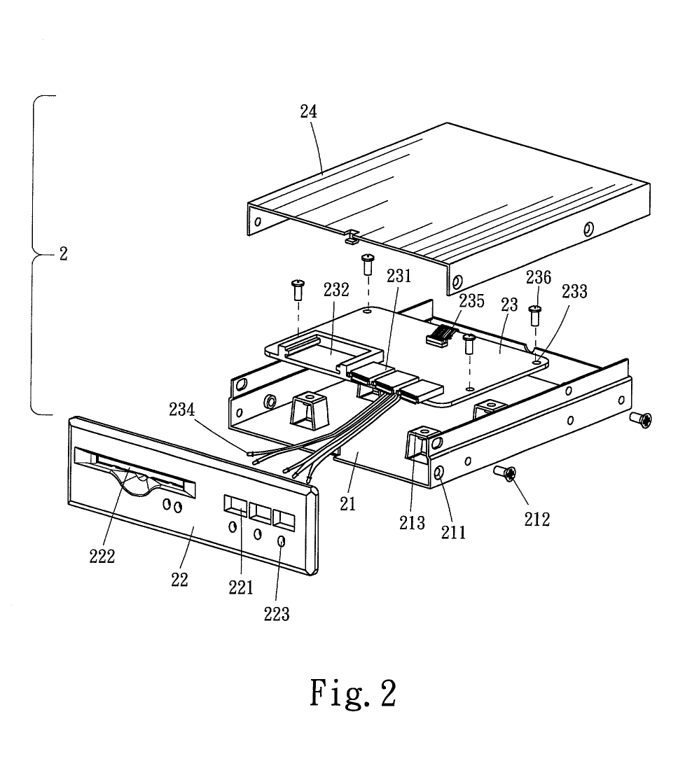

Referring to FIG. 2, an embodiment about the built-in computer USB HUB and card reader 2 is illustrated. The built-in computer USB HUB and card reader 2 includes a USB connecting seat and card reading elements and is installed in a disk rack of a computer casing as a slot seat which serves as a computer standard equipment. The built-in computer USB HUB and card reader 2 has a slot seat 21, a panel 22, a circuit board 12, an upper cover plate 24, etc.

As illustrated in the drawings, by the slot seat of the built-in computer USB HUB and card reader 2 of the present invention, the screw holes 211 and screws 212 can be engaged, the whole built-in computer USB HUB and card reader 2 can be screwed to the computer disk rack. Threaded pieces 213 are on the slot seat 21.

The circuit board 23 has a USB HUB input terminal 231, a card reader element 232, screw holes 233, LED indicators 234 and an output bank 235 connected to a computer mainframe. The output bank 235 serves for inputting signals to a computer mainframe or outputting signals from a computer mainframe and supplying power to a power source. In fixing, screws 236 pass through the screw holes 233 so as to be fixed to the threaded pieces 213 of the slot seat 21.

The built-in computer USB HUB and card reader 2 of the present invention has a panel 22 which is conformed to the slot seat 21 and the upper cover plate 24. The panel 22 has a USB HUB input terminal notch 221, a memory card inlet 222 and a plurality of LED indicator installing hole 223, etc. at positions with respect to the USB HUB input terminal 231, a card reading element 223 and LED indicators 234. The slot seat 21, panel 2, and upper cover plate 24 are assembled as a built-in computer USB HUB and card reader 2. Thereby, by above mentioned USB HUB and card reader device, the present invention is formed.

It should be noted, the built-in computer USB HUB and card reader 2 and the used slot seat 21 may be made with a size suitable for 3.5 inch and 5.25 inch disk slots of general computer casing, or the 3.5 inch slot seat 21 is added with a desired auxiliary rack so as to be used by a 5.25 disk slot.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A computer USB HUB and card reader combining device being a shared plug-in and built-in computer USB HUB and card reader device; wherein
the plug-in computer USB HUB and card reader has a box seat, a circuit board and an upper cover; the box seat has screw holes, a flange, a upper cover, a USB output terminal notch, a hole, a memory card inlet;
he circuit board has a plurality of penetrating holes, a USB HUB input terminal, a USB HUB output terminal, a DC power terminal and a card reading element; DC power from an external power transformer is inputted from the DC power terminal;
the upper cover is installed with a USB output terminal notch, DC power terminal notch and threads; thereby, the screws is screwed into the box seat so that the circuit board and upper cover are formed as an integral body; then they are connected to a computer mainframe so that the user can use the functions of card reading of USB and HUB;
the built-in computer USB HUB and card reader includes a USB connecting seat and card reading elements and is installed in a disk rack of a computer casing as a slot seat which serves as a computer standard equipment; the built-in computer USB HUB and card reader has a slot seat, a panel, a circuit board, an upper cover plate;
by the slot seat of the built-in computer USB HUB and card reader, the screw holes and screws are engaged, the whole built-in computer USB HUB and card reader is screwed to the computer disk rack; threaded pieces are on the slot seat;
the circuit board has a USB HUB input terminal, a card reader element, screw holes, LED indicators and an output bank connected to a computer mainframe; the output bank serves for inputting signals to a computer mainframe or outputting signals from a computer mainframe and supplying power to a power source; in fixing, screws pass through the screw holes so as to be fixed to the threaded pieces of the slot seat; and
the built-in computer USB HUB and card reader has a panel which is conformed to the slot seat and the upper cover plate; the panel has a USB HUB input terminal notch, a memory card inlet and a plurality of LED indicator installing hole, etc. at positions with respect to the USB HUB input terminal, a card reading element and LED indicators; the slot seat, panel, and upper cover plate are assembled as a built-in computer USB HUB and card reader; thereby, by above mentioned USB HUB and card reader device, a computer USB HUB and card reader combining device is formed.

2. The computer USB HUB and card reader combining device as claim in claim 1, wherein the built-in computer USB HUB and card reader and the slot seat are made with a size suitable for 3.5 inch and 5.25 inch disk slots of general computer casing, the 3.5 inch slot seat is added with a desired auxiliary rack so as to be used by a 5.25 disk slot.
